(19) United States
(12) Patent Application Publication
(10) Pub. No.: US 2019/0244391 A1
(43) Pub. Date: Aug. 8, 2019

(54) AN AERIAL CAMERA BORESIGHT CALIBRATION SYSTEM

(71) Applicant: Spookfish Innovations PTY LTD, Bentley (AU)

(72) Inventor: Simon Cope, Burswood (AU)

(21) Appl. No.: 16/343,678

(22) PCT Filed: Oct. 20, 2017
(86) PCT No.: PCT/AU2017/051139

§ 371 Date: Apr. 19, 2019

(30) Foreign Application Priority Data
Oct. 20, 2016 (AU) 2016904254

(51) Int. Cl. G06T 7/80; G03B 15/00; G06F 17/11; G06K 9/00

(52) U.S. Cl. CPC G06T 7/80; G03B 15/006; G03B 2205/0007; G06K 9/0063; G06T 2207/10032; G06F 17/11

(57) ABSTRACT

Boresight calibration systems and methods are disclosed for calibrating line of sight data of an imaging system. The boresight calibration system may be arranged to calculate boresight calibration parameters for images captured by the imaging system using line of sight data associated with first images of an existing bundle adjustment solution captured in a first aerial survey, and at least one image capture parameter associated with the first images and indicative of respective positions of at least one movable image capture component of the imaging system, arranged to move during an aerial survey, when the first images are captured in the first aerial survey and to apply the calculated boresight calibration parameters to line of sight data associated with second images captured in a second aerial survey that have not been bundle adjusted.

### FIELD OF THE INVENTION

The present invention relates to an aerial camera boresight calibration system for use in an aerial survey.

### BACKGROUND OF THE INVENTION

It is known to provide an aerial camera system that is arranged to capture ground images from a survey aircraft. Typically, as shown in FIG. 1, the aerial camera system 12 is mounted to an underside portion of the survey aircraft 10 and ground images are captured as the survey aircraft 10 moves along defined flight lines. The system is arranged to capture multiple images for each ground feature, which enables a photogrammetric solution, typically a bundle adjustment process, to be applied to the captured images in order to determine a best case solution for interior and exterior orientation information associated with each camera used and the images captured by each camera. The solution produced by the bundle adjustment process may then be used to produce nadir and/or oblique photomaps.

In order to improve the photogrammetric solution produced by the bundle adjustment process, the number of images taken for each ground feature must be increased, and typically this is achieved by capturing images more frequently so that the overlap between successively captured images is increased, and by ensuring that sufficient overlap exists between adjacent flight lines.

Productivity in relation to the ground area captured per hour at a defined resolution can potentially be increased by flying faster, flying higher and/or using a wider field of view (FoV).

However, such techniques typically cause image blur.

Therefore, in order to improve image resolution, motion compensation techniques are employed, for example as described in applicants co-pending International Patent Application No. PCT/AU2015/000606, the contents of which are hereby incorporated by reference.

A typical survey aircraft includes one or more cameras for capturing images, and an Inertial Navigation System (INS) that is used to determine the movement, position and orientation of the survey aircraft and thereby the position and pose of the camera(s), typically using a GPS and an Inertial Measurement Unit (IMU) that uses accelerometers and gyroscopes for each spatial axis.

Boresight calibration is a process of determining the parameters that describe the static misalignment between the IMU derived pose and the actual camera optical center, which occurs due to a combination of manufacturing and assembly tolerances. The calibration parameters comprise x, y, and z axis rotation values that are used to bring the camera system and the IMU into closer alignment so that the line of sight (also referred to as exterior orientation for each image) determined using the IMU is as close as practical to the actual line of sight of the camera(s).

While the angular errors between the rotational values determined using the IMU and the actual camera rotational values may be numerically small, a 0.1 degree pointing error between them results in a significant 4.36 m positional error from 2,500 m away. This is a significant issue for high-altitude image capture systems.

Although it is possible to resolve these errors as part of the bundle adjustment process, the significant errors between the IMU determined rotational values and the actual camera rotational values causes the process to be cumbersome and time consuming.

The combined x, y, and z misalignment in this example results in an initial solution with residual Root Mean Square (RMS) errors of over 15 m. This level of misalignment makes automated aerial triangulation (AT) processing in a bundle adjustment process very slow as the search range needs to be made very large to find matching feature observations across multiple overlapping images.

A typical arrangement for determining boresight calibration parameters for a camera system is to setup a special test field, or perform dedicated calibration flights, but such arrangements are time consuming, expensive and operationally limiting.

For aerial camera systems that include scanning-type cameras, the problem is exacerbated because the required boresight calibration parameters are unlikely to be constant across the entire range of motion—either Field of Regard (FoR) scanning range or Motion Compensation (MC) range. This is because multiple misalignments in rotating components can create multiple, potentially eccentric, misalignments.

In FIG. 2, epipolar lines 14 of feature observations for a common control point 16 when modelled with a single static boresight calibration show the effect of such misalignments on the reprojection accuracy in a scanning camera system.

### SUMMARY OF THE INVENTION

It will be understood that as the accuracy of the initial boresight alignment increases, the speed and robustness of the bundle adjustment solution will also increase and, therefore, by determining more accurate boresight calibration parameters for a given camera system, it is possible to improve the speed and efficiency of the bundle adjustment process.

In accordance with a first aspect of the present invention, there is provided a boresight calibration system for calibrating line of sight data of an imaging system, the line of sight data indicative of a line of sight determined during use for an image captured by the imaging system, and the imaging system including at least one image capture component arranged to move during an aerial survey, the boresight calibration system arranged to:
calculate boresight calibration parameters for images captured by the imaging system using:
   line of sight data associated with first images of an existing bundle adjustment solution captured in a first aerial survey; and
   at least one image capture parameter associated with the first images, the at least one image capture parameter indicative of respective positions of at least one movable image capture component of the imaging system when the first images are captured in the first aerial survey; and
apply the calculated boresight calibration parameters to line of sight data associated with second images captured in a second aerial survey that have not been bundle adjusted, the calculated boresight calibration parameters applied according to the respective positions of the at least one movable image capture component of the imaging system when the second images are captured in the second aerial survey.

In an embodiment, each boresight calibration parameter is a calibration parameter associated with a rotational component of line of sight data, for example an x, y or z rotational component of the line of sight data.

The boresight value may be expressed as a rotational matrix Rₘₐₜ having x, y and z rotational components.

In an embodiment, the system is arranged to store boresight calibration parameters in a lookup table, wherein each entry in the lookup table is associated with at least one image capture parameter. The lookup table may be a multi-dimensional lookup table dependent on the number of image capture parameters.

In an embodiment, at least some boresight calibration parameters in the lookup table are determined by interpolation.

In an embodiment, the system is arranged to determine a polynomial representative of a relationship between a boresight calibration parameter and at least one image capture parameter, and to use the polynomial to calculate a boresight calibration parameter using the at least one image capture parameter.

In an embodiment, the line of sight data associated with the captured second images is obtained using an inertial measurement unit (IMU) disposed during use on the survey aircraft.

In an embodiment, the imaging system is a rotating camera imaging system wherein a camera field of view moves in an oscillating manner across track.

In an embodiment, the at least one image capture parameter includes a rotational position of the camera assembly.

In an embodiment, the rotating camera imaging system includes at least one forward motion compensation component arranged to compensate for image blur caused by forward movement.

In an embodiment, the at least one image capture parameter includes a position associated with the forward motion compensation component.

In an embodiment, the rotating camera imaging system includes at least one across track compensation component arranged to compensate for image blur caused by across track movement.

In an embodiment, the at least one image capture parameter includes a position associated with the across track motion compensation component.

In an embodiment, the system is arranged to calculate the boresight calibration parameters on the survey aircraft.

In an embodiment, the system is arranged to store uncalibrated line of sight data on the survey aircraft for subsequent transfer to a processing facility, and to calculate the boresight calibration parameters at the processing facility.

In accordance with a second aspect of the present invention, there is provided method of calibrating line of sight data of an imaging system, the line of sight data indicative of a line of sight determined during use for an image captured by the imaging system, and the imaging system including at least one image capture component arranged to move during an aerial survey, the method comprising:
calculating boresight calibration parameters for images captured by the imaging system using:
   line of sight data associated with first images of an existing bundle adjustment solution captured in a first aerial survey; and
   at least one image capture parameter associated with the first images, the at least one image capture parameter indicative of respective positions of at least one movable image capture component of the imaging system when the first images are captured in the first aerial survey; and
applying the calculated boresight calibration parameters to line of sight data associated with second images captured in a second aerial survey that have not been bundle adjusted, the calculated boresight calibration parameters applied according to the respective positions of the at least one movable image capture component of the imaging system when the second images are captured in the second aerial survey.

### BRIEF DESCRIPTION OF THE DRAWINGS

The present invention will now be described, by way of example only, with reference to the accompanying drawings, in which:

FIG. 1 is a diagrammatic representation of a survey aircraft incorporating an aerial camera system;

FIG. 2 shows epipolar lines of feature observations for a common control point in a conventional aerial survey with a single static boresight calibration arrangement;

FIG. 3 is a diagrammatic perspective view of a camera assembly of an aerial camera system, the camera assembly including a stabilisation assembly;

FIG. 4 is a block diagram illustrating operative components of an aerial camera boresight calibration system in accordance with an embodiment of the present invention;

FIG. 5 is a flow diagram illustrating a method of determining boresight calibration parameters according to an embodiment of the present invention;

FIG. 6 is a flow diagram illustrating a method of calibrating boresight in an aerial camera system using lookup tables;

FIG. 7 is a flow diagram illustrating a method of calibrating boresight in an aerial camera system using polynomial;

FIG. 8 is a graph illustrating a relationship between tube rotation in a rotating tube-type camera assembly of an aerial camera system and an x axis calibration parameter for a defined camera line of sight and therefore captured image; and

FIG. 9 shows epipolar lines of feature observations for a common control point in an aerial survey that uses an aerial camera boresight calibration system in accordance with an embodiment of the present invention.

### DESCRIPTION OF AN EMBODIMENT OF THE INVENTION

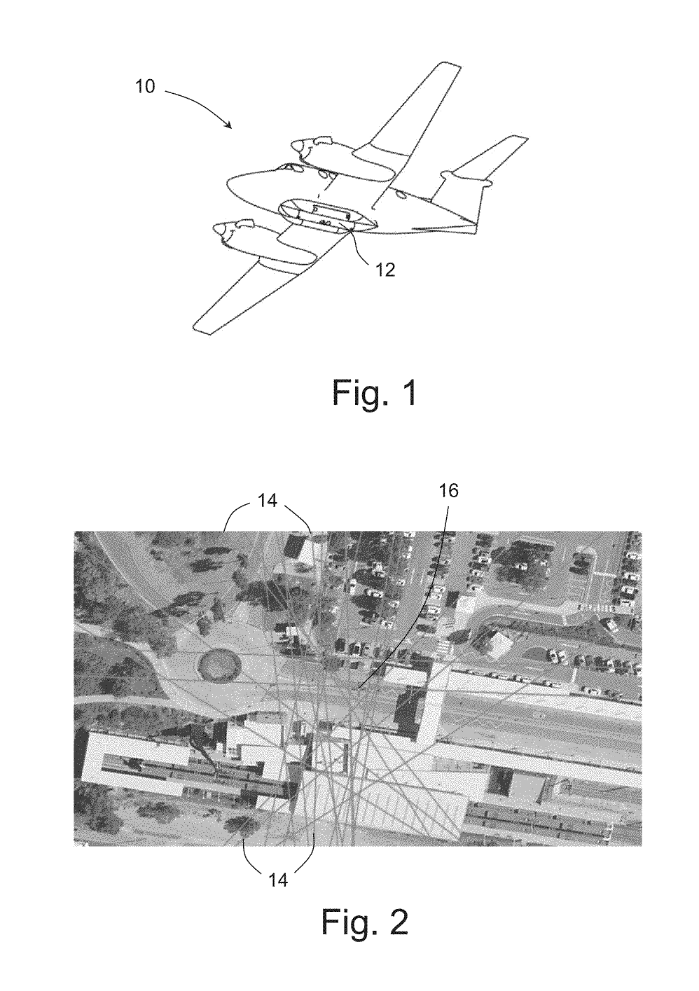

Referring to FIG. 1 of the drawings, a survey aircraft 10 with mounted aerial camera system 12 is shown.

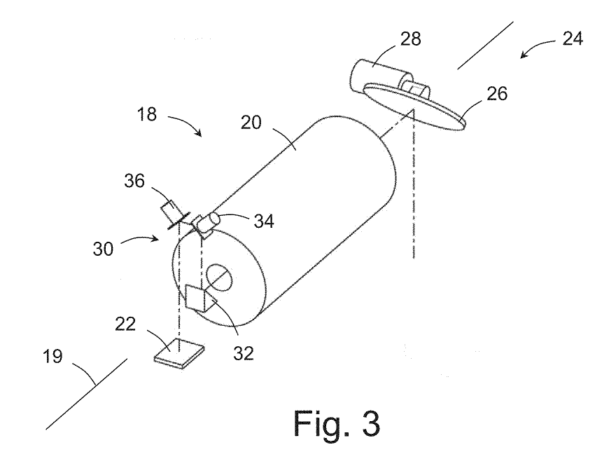

As shown in FIG. 3, the aerial camera system 12 is of a type described in applicants co-pending International Patent Application No. PCT/AU2015/000606, the contents of which are hereby incorporated by reference.

The aerial camera system 12 in this example includes a camera assembly 18 arranged to rotate about a central longitudinal axis 19. The camera assembly 18 includes a lens assembly 20, a sensor assembly 22 and a steering mirror assembly 24. The steering mirror assembly 24 is mounted so as to be positioned at a nominal down angle of about 45° so that light from the ground directly beneath the survey aircraft 10 is directed towards the lens assembly 20 and is in turn focused by the lens assembly 20 onto the sensor assembly 22.

In this example, each sensor in the sensor assembly 22 has a resolution of about 5 μm, pixel dimensions of about 5000×3883 and is capable of capturing about 10 frames per second, although it will be understood that other sensor variations are envisaged. The sensor may be a CMOS sensor with LCD shutter and in this example 2 sensors may be provided in the sensor assembly 22.

In this example, the lens assembly 20 has a focal length of about 376 mm, although other focal lengths are envisaged, such as 1800 mm.

The steering mirror assembly 24 in this example includes a steering mirror 26 and a steering actuator 28 arranged to controllably rotate the steering mirror 26 about a generally transverse axis. The steering actuator 28 may include a rotary piezo-electric mechanism.

The steering mirror assembly 24 operates so as to rotate the steering mirror 26 at a rate corresponding to the instantaneous speed of the survey aircraft 10 and in this way provides a degree of compensation for image blur caused by forward movement of the survey aircraft 10. This is achieved by effecting partial rotation of the steering mirror 26 in a direction so as to at least partially compensate for blur caused by forward motion of the survey aircraft 10, followed by rapid rotational movement of the steering mirror 26 in an opposite rotational direction to bring the steering mirror 26 back to a start position.

It will be understood that as the aircraft moves forwards, a plurality of images are captured ‘across track’, that is, in a direction perpendicular to the direction of movement of the survey aircraft 10, by rotating the camera assembly 18 about the central axis 19, capturing images periodically as the camera assembly 18 rotates, and repeatedly moving the camera assembly 18 back to a start rotational position.

While scanning the camera assembly 18 in this way enables multiple images to be captured at relatively low field of view with a lens of relatively high focal length and thereby relatively high resolution, rotating the camera assembly 18 causes significant image blur.

Image blur is also affected by movement of the survey aircraft 10, including instantaneous roll of the survey aircraft 10.

In order to at least partially compensate for image blur, the camera assembly 18 also includes a stabilisation assembly 30 including a primary folding mirror 32 that receives light from the lens assembly 20 and reflects the light at 90° towards a first fast steering mirror 34. The first fast steering mirror 34 reflects the light at approximately 90° towards a second fast steering mirror 36, which then reflects the light at approximately 90° towards the sensor assembly 22.

In this example, each of the first and second fast steering mirrors 34, 36 is a front coated optically flat articulating mirror mounted to an actuator that is capable of rapidly rotating a movable mirror, in this embodiment using a rotary piezo-electric mechanism. By synchronizing rotational movement of the articulating mirrors with rotational movement of the lens assembly 20, it is possible to effectively stabilize an image on the sensor of the sensor assembly 22 and thereby reduce image blur.

The survey aircraft 10 also includes an Inertial Navigation System (INS) having a GPS unit and an Inertial Measurement Unit (IMU). The INS is arranged to determine the movement, position and orientation of the survey aircraft 10 in real time, and this information is used with orientation information associated with the camera assembly 18 to provide information indicative of an estimated camera line of sight for each captured image in terms of x, y and z rotational values. The present system determines x, y and z calibration parameters to be applied to the estimated boresight information to improve the accuracy of the estimated line of sight data so as to be closer to the actual line of sight of the camera assembly 18.

The camera assembly 18 is arranged such that the field of regard (FoR) is directed generally vertically downwards in order to capture images of the ground directly beneath the survey aircraft 10. In this example, the images are used to produce high resolution ortho imagery with approximately 70% forward and 2% side overlap between frames, and approximately 70% side overlap between the ground coverage footprints of adjacent flight lines.

This arrangement provides a relatively high redundancy for the images captured by the camera assembly 18.

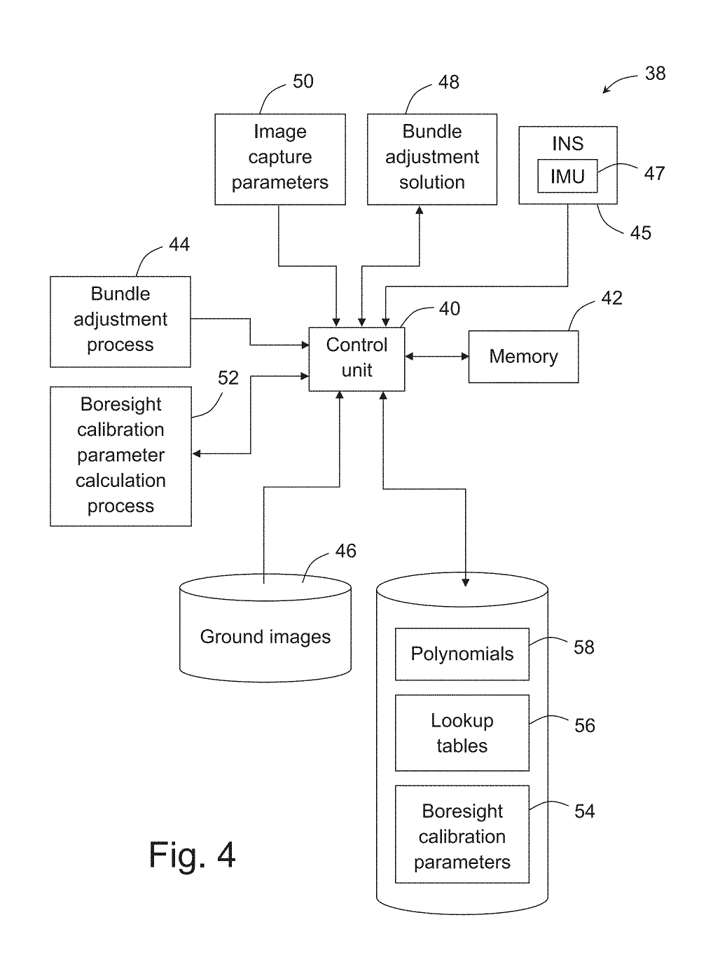

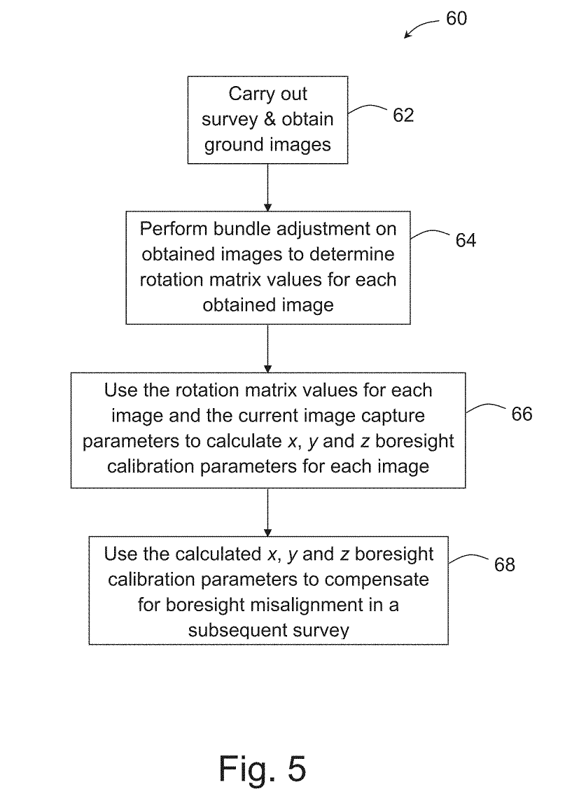

Operative components of an aerial camera boresight calibration system 38 are shown in FIG. 4 and a flow diagram 60 including steps 62 to 68 of a process for generating boresight calibration parameters 54 for a particular camera system is shown in FIG. 5.

The system 38 in this example is usable to determine boresight calibration parameters 54 from previously captured and bundle adjusted survey images 46, and to apply the boresight calibration parameters 54 to newly captured images prior to or as part of a bundle adjustment process. It will be understood, therefore, that the system 38 in this example is arranged to carry out both a bundle adjustment process and a boresight calibration process, although it will be understood that other arrangements are possible, such as separate systems to carry out these processes.

The system 38 includes a control unit 40 arranged to control and coordinate operations in the system 38, and a memory 42 arranged to load processes implemented by the control unit 40. In this example, the system 38 is implemented using a personal computer and as such the control unit 40 may be implemented using a processor and associated programs. However, it will be understood that any suitable implementation is envisaged.

In order to generate boresight calibration parameters 54 from previously captured and bundle adjusted survey images, a survey is carried out 62 and a bundle adjustment process 44 implemented 64 to produce a bundle adjustment solution 48, for example using bundle adjustment program data from a data storage device. The bundle adjustment process is carried out on captured ground images 46 and associated line of sight data derived from an Inertial Measurement Unit (IMU) 47 on the survey aircraft. It will be understood that this process may be relatively time consuming because significant residual Root Mean Square (RMS) errors may exist with the IMU derived data which will affect automated Aerial Triangulation (AT) processing in the bundle adjustment process.

Using the bundle adjustment solution 48, a distinct set of x, y and z boresight calibration parameters is calculated 66 using a boresight parameter calibration process 52 for at least one image capture parameter 50 associated with movable components of the camera system. In this example, the specific image capture parameters 50 may include the rotational position of the camera assembly 18, the position of the forward motion compensation stabilisation mirror 26, and/or the positions of the first and second fast steering mirrors 34, 36. In this way, 3 boresight rotational calibration parameters (x, y and z) are produced for each captured image and associated camera assembly line of sight (boresight). The calculation is based on the following relationship:

Rₘₐₜ=CameraBoresight*ImageCaptureParameters*IMUPosition

where Rₘₐₜ is the rotation matrix for a captured image in the final bundle adjusted solution, CameraBoresight is a calibration parameter that corrects a misalignment between the line of sight determined using the IMU and the actual camera assembly optical line of sight, ImageCaptureParameters are the parameters of the image capture arrangement in the survey aircraft that affect the line of sight of the camera assembly, and IMUPosition is a rotational position derived from the IMU.

In the following example, a camera assembly is provided that has a rotating camera tube affecting the line of sight of the camera assembly.

With this example, the Rₘₐₜ calculation is:

Rₘₐₜ=CameraOrientation*CameraBoresight*TubeRotation*TubeOrientation*BodyToNED*NED2World

where CameraOrientation is the orientation of the camera assembly, TubeRotation is the rotational position of the rotatable lens assembly, TubeOrientation is the orientation of the rotatable lens assembly, BodyToNED is a rotation matrix from the body coordinate frame to the North-East-Down frame, and NED2World is a rotation matrix from the North-East-Down frame to the World frame.

Therefore, given a final bundle adjusted Rₘₐₜ for a captured image from a survey, orientation data derived from the IMU, and a tube rotation image capture parameter, it is possible to determine the appropriate boresight calibration parameters for the captured image according to:

CameraBoresight=CameraOrientation⁻¹*Rmat*(TubeRotation*TubeOrientation*BodyToNED*NEDToWorld)⁻¹

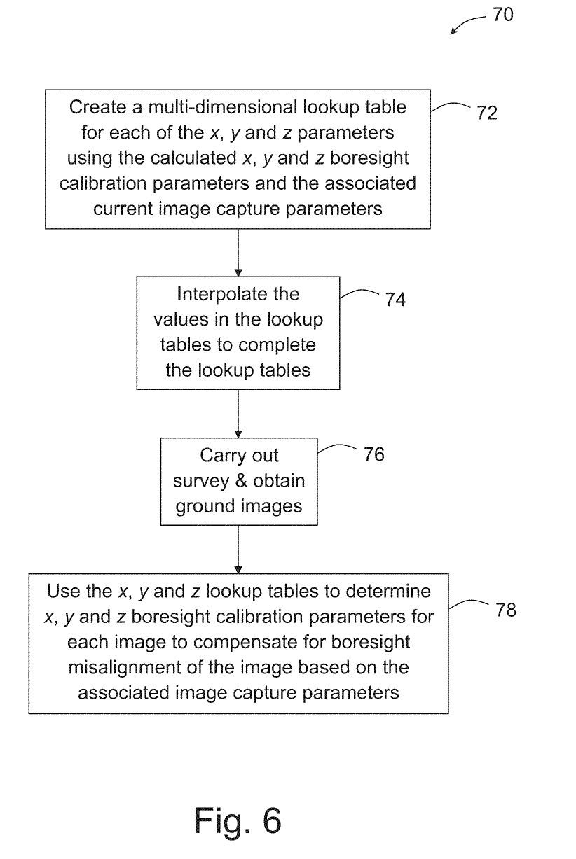

As shown in FIG. 6, a flow diagram 70 is shown including steps 72 to 78 of an example process for calibrating line of sight data in an aerial camera system. Using the calculated boresight parameters 54, calibrated line of sight data can be produced for all images in a survey.

The calculated boresight calibration parameters 54 are in this example stored and used to create 72 a multi-dimensional lookup table 56. For example, if the image capture parameters include camera assembly rotation and forward motion compensation mirror position values that continually change during a survey, a 2 dimensional lookup table based on the camera assembly rotation and forward motion compensation mirror position values may be created. A suitable interpolation method such as bicubic interpolation may also be employed to complete the lookup table, if required.

The lookup table 56 can then be used 78 to provide x, y and z boresight calibration parameters for each captured image during a subsequent bundle adjustment process using the image capture parameters, in this example the camera assembly rotation and forward motion compensation mirror position values for the images.

As a consequence, the speed and efficiency of the bundle adjustment process is much improved because the misalignment for each image between the line of sight determined using the IMU and the actual camera assembly line of sight is reduced.

The above process for producing boresight calibration parameters based on a previous bundle adjusted solution may be repeated, for example periodically, so as to maintain the boresight calibration parameters current and thereby take into account any potential changes that may have occurred to the boresight alignment, for example due to wear of the IMU, vibration induced changes, mechanical shocks, and so on.

In aerial camera systems wherein a small number of movable components exist that affect the line of sight of the camera assembly, alternative arrangements could be used to provide boresight calibration parameters during a subsequent bundle adjustment process.

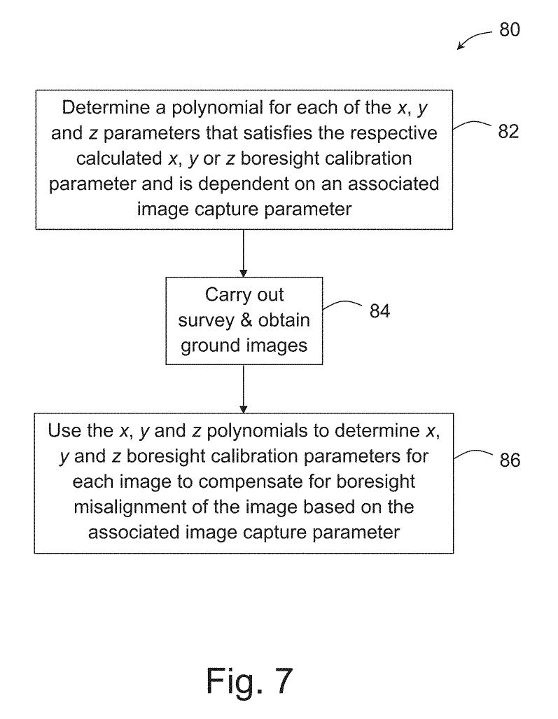

For example, FIG. 7 shows a flow diagram 80 including steps 82 to 86 of an alternative example process for calibrating line of sight data in an aerial camera system. Instead of a lookup table, the system 38 calculates 82 a polynomial function for each of the x, y and z calibration parameters that satisfies a set of calibration parameters calculated according to the flow diagram 60 shown in FIG. 5.

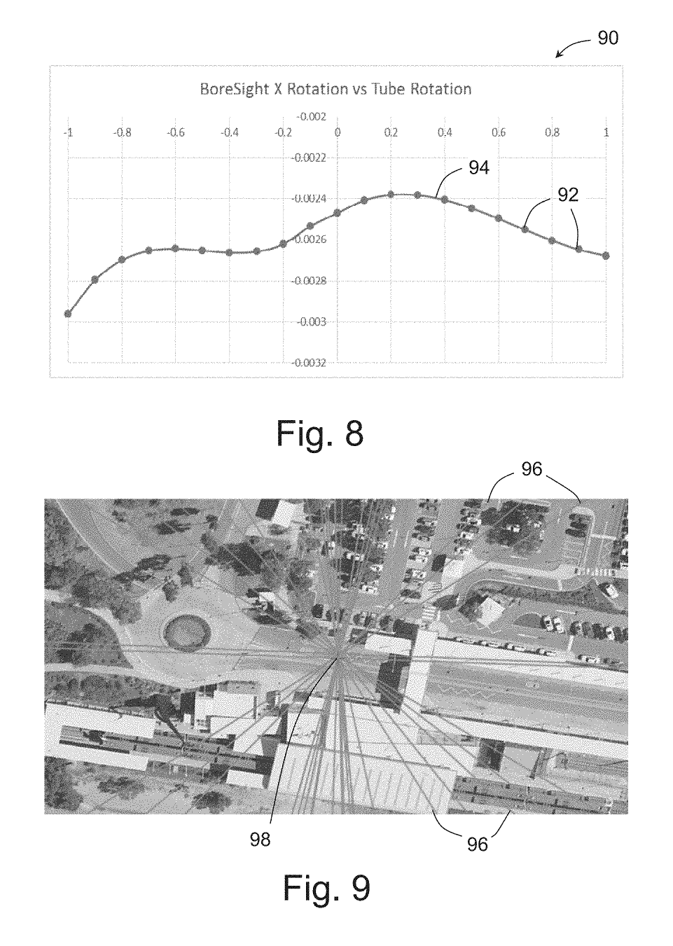

For example, as shown in FIG. 8, a plot 90 is shown of calculated x axis rotation calibration parameters 92 with respect to camera tube rotation, and a polynomial 94 that satisfies the calibration parameters.

Using the defined polynomials for the x, y and z rotations, x, y and z calibration parameters can be determined 86 based on the small number of image capture parameters.

In the present example wherein the image capture parameter is camera tube rotation, a 3rd order polynomial for the x axis rotation calibration parameter can be defined according to:

Xᵣₒₜ=ar³+br²+cr+d

where Xᵣₒₜ is the x axis rotation calibration parameter; r is the camera tube rotation; and a, b, c and d are constants.

Solving this for the calculated calibration parameters 92 gives:
Positive Rotation:
   a=0.00101549346557871
   b=−0.00203326391154181
   c=0.00080941995322413
   d=−0.00247017326964766
Negative Rotation:
   a=−0.00281898194632555
   b=0.00415010191459033
   c=−0.00191215176100009
   d=−0.00238148035772705

Using the present system and method, good boresight calibration can be achieved that is sufficient to enable high-speed, highly robust fully automated aerial triangulation.

It will be understood that the components of the aerial camera boresight calibration system necessary for determining the boresight calibration parameters using a lookup table or polynomials may be disposed on the survey aircraft 10, and calibrated line of sight data stored on the survey aircraft 10 during a survey for subsequent transfer to a land based facility for bundle adjustment processing. Alternatively, non-calibrated line of sight data may be stored at the survey aircraft 10 and subsequently transferred to the land based facility for calibration using the boresight calibration parameters, and bundle adjustment processing.

It will also be appreciated that the present method and system are also applicable to dynamic boresight calibration in other scanning systems such as airborne and ground-based LIDAR.

Modifications and variations as would be apparent to a skilled addressee are deemed to be within the scope of the present invention.

1. A boresight calibration system for calibrating line of sight data of an imaging system disposed on an aircraft, the line of sight data indicative of a line of sight determined during use for an image captured by the imaging system, the boresight calibration system arranged to:
calculate boresight calibration parameters for images captured by the imaging system disposed on the aircraft using:
line of sight data associated with first images of an existing bundle adjustment solution captured in a first aerial survey; and
at least one image capture parameter associated with the first images, the at least one image capture parameter indicative of respective positions of at least one movable image capture component of the imaging system when the first images are captured in the first aerial survey, the at least one moveable image capture component movable relative to the aircraft; and
apply the boresight calibration parameters to line of sight data associated with second images captured in a second aerial survey that have not been bundle adjusted, the boresight calibration parameters applied according to the respective positions of the at least one movable image capture component of the imaging system when the second images are captured in the second aerial survey.

2. The boresight calibration system as claimed in claim 1, wherein each boresight calibration parameter is a calibration parameter associated with a rotational component of line of sight data, for example an x, y or z rotational component of the line of sight data.

3. The boresight calibration system as claimed in claim 2, wherein the boresight value is expressed as a rotational matrix Rₘₐₜ having x, y and z rotational components.

4. The boresight calibration system as claimed in claim 1, wherein the boresight calibration system is arranged to store boresight calibration parameters in a lookup table, wherein each entry in the lookup table is associated with at least one image capture parameter.

5. The boresight calibration system as claimed in claim 4, wherein the lookup table is a multi-dimensional lookup table dependent on the number of image capture parameters.

6. The boresight calibration system as claimed in claim 4, wherein at least some boresight calibration parameters in the lookup table are determined by interpolation.

7. The boresight calibration system as claimed in claim 1, wherein the boresight calibration system is arranged to determine a polynomial representative of a relationship between at least one boresight calibration parameter and at least one image capture parameter, and to use the polynomial to calculate a boresight calibration parameter using the at least one image capture parameter.

8. The boresight calibration system as claimed in claim 1, wherein the line of sight data associated with the captured second images is obtained using an inertial measurement unit (IMU) disposed during use on the aircraft.

9. The boresight calibration system as claimed in claim 1, wherein the imaging system is a rotating camera imaging system comprising a camera assembly having a camera field of view, and wherein the camera field of view moves in an oscillating manner across track.

10. The boresight calibration system as claimed in claim 9, wherein the at least one image capture parameter includes a rotational position of the camera assembly.

11. The boresight calibration system as claimed in claim 9, wherein the rotating camera imaging system includes at least one forward motion compensation component arranged to compensate for image blur caused by forward movement.

12. The boresight calibration system as claimed in claim 11, wherein the at least one image capture parameter includes a position associated with the forward motion compensation component.

13. The boresight calibration system as claimed in claim 9, wherein the rotating camera imaging system includes at least one across track compensation component arranged to compensate for image blur caused by across track movement.

14. The boresight calibration system as claimed in claim 13, wherein the at least one image capture parameter includes a position associated with the across track motion compensation component.

15. The boresight calibration system as claimed in claim 1, wherein the system is arranged to calculate the boresight calibration parameters on the aircraft.

16. The boresight calibration system as claimed in claim 1, wherein the system is arranged to store uncalibrated line of sight data on the aircraft for subsequent transfer to a processing facility, and to calculate the boresight calibration parameters at the processing facility.

17. A method of calibrating line of sight data of an imaging system disposed on an aircraft, the line of sight data indicative of a line of sight determined during use for an image captured by the imaging system, the method comprising:
calculating boresight calibration parameters for images captured by the imaging system disposed on the aircraft using:
line of sight data associated with first images of an existing bundle adjustment solution captured in a first aerial survey; and
at least one image capture parameter associated with the first images, the at least one image capture parameter indicative of respective positions of at least one movable image capture component of the imaging system when the first images are captured in the first aerial survey, the at least one movable image capture component movable relative to the aircraft; and
applying the calculated boresight calibration parameters to line of sight data associated with second images captured in a second aerial survey that have not been bundle adjusted, the calculated boresight calibration parameters applied according to the respective positions of the at least one movable image capture component of the imaging system when the second images are captured in the second aerial survey.

18. The method as claimed in claim 17, wherein each boresight calibration parameter is a calibration parameter associated with a rotational component of line of sight data, for example an x, y or z rotational component of the line of sight data.

19. The method as claimed in claim 18, wherein the boresight value is expressed as a rotational matrix Rₘₐₜ having x, y and z rotational components.

20. The method as claimed in claim 17, comprising storing boresight calibration parameters in a lookup table, wherein each entry in the lookup table is associated with at least one image capture parameter.

21. The method as claimed in claim 20, wherein the lookup table is a multi-dimensional lookup table dependent on the number of image capture parameters.

22. The method as claimed in claim 20, comprising determining at least some boresight calibration parameters in the lookup table by interpolation.

23. The method as claimed in claim 17, comprising determining a polynomial representative of a relationship between a boresight calibration parameter and at least one image capture parameter, and using the polynomial to calculate a boresight calibration parameter using the at least one image capture parameter.

24. The method as claimed in claim 17, comprising obtaining the line of sight data associated with the captured second images using an inertial measurement unit (IMU) disposed during use on the aircraft.

25. The method as claimed in claim 17, wherein the imaging system is a rotating camera imaging system comprising a camera assembly having a camera field of view, and wherein the camera field of view moves in an oscillating manner across track.

26. The method as claimed in claim 25, wherein the at least one image capture parameter includes a rotational position of the camera assembly.

27. The method as claimed in claim 25, wherein the rotating camera imaging system includes at least one forward motion compensation component arranged to compensate for image blur caused by forward movement.

28. The method as claimed in claim 27, wherein the at least one image capture parameter includes a position associated with the forward motion compensation component.

29. The method as claimed in claim 25, wherein the rotating camera imaging system includes at least one across track compensation component arranged to compensate for image blur caused by across track movement.

30. The method as claimed in claim 29, wherein the at least one image capture parameter includes a position associated with the across track motion compensation component.

31. The method as claimed in claim 17, comprising calculating the boresight calibration parameters on the aircraft.

32. The method as claimed in claim 17, comprising storing uncalibrated line of sight data on the aircraft for subsequent transfer to a processing facility, and calculating the boresight calibration parameters at the processing facility.
